(19) United States
(12) Patent Application Publication
(10) Pub. No.: US 2026/0154750 A1
(43) Pub. Date: Jun. 4, 2026

(54) SYSTEM AND METHOD FOR EDUCATIONAL INVESTMENT ANALYSIS

(71) Applicants: Melanie Hanna, Prosper, TX (US); Michael Hanna, Prosper, TX (US)

(72) Inventors: Melanie Hanna, Prosper, TX (US); Michael Hanna, Prosper, TX (US)

(21) Appl. No.: 19/263,045

(22) Filed: Jul. 8, 2025

Related U.S. Application Data
(63) Continuation of application No. 19/012,605, filed on Jan. 7, 2025, now abandoned.
Application No. 19/012,605 is a continuation of application No. 18/642,733, filed on Apr. 22, 2024, now abandoned.
(60) Provisional application No. 63/538,003, filed on Sep. 12, 2023.

(51) Int. Cl. G06Q 40/06; G06Q 50/20

(52) U.S. Cl. CPC G06Q 40/064; G06Q 50/205

(57) ABSTRACT

A system and method for educational investment analysis assists students in making informed decisions regarding their educational and financial futures. User input is captured detailing educational and financial planning, including intended occupation, potential college choices, and funding plans. The user input is integrated with external data on tuition costs, average salaries, and living expenses. Multiple projected scenarios are generated depicting different educational and financial outcomes based on different choices. Evaluative metrics are calculated for each scenario, including return on investment (ROI), debt repayment period, and earning potential. A comparative analysis of the scenarios is conducted and the results are displayed in a user-friendly visual format enabling clear comparisons and informed choices.

### CROSS-REFERENCE TO RELATED APPLICATIONS

This application is a continuation-in-part of U.S. Provisional Application No. 63/538,003, filed on Sep. 12, 2023, which is hereby incorporated by reference in its entirety.

### BACKGROUND

### 1. Field of the Invention

The present invention relates generally to educational planning tools, and more specifically to an automated system and method for aiding students in making informed decisions about prospective educational investment options.

### 2. Description of Related Art

Existing educational planning tools offer various functionalities, primarily focusing on elements like academic pathway planning, financial aid estimation, and basic cost analysis. These tools often provide segmented insights, addressing specific components of the educational journey, such as tuition costs or scholarship opportunities.

One of the problems commonly associated with conventional educational planning tools is the lack of a comprehensive tool that integrates multiple aspects of a student's educational and post-educational life. Existing systems tend to overlook the importance of combining educational pathways with detailed financial planning, including ROI, debt repayment timelines, and post-graduation financial scenarios. Furthermore, there is a notable absence of tools that allow for scenario-based comparisons, where students can evaluate different educational and financial strategies side by side to compare specific potential choices against each other.

Accordingly, although great strides have been made in the area of educational planning tools, many shortcomings remain. It is therefore an object of the present invention to provide an integrated, data-driven solution that offers a comprehensive analysis of educational pathways, funding options, and post-graduation outcomes to facilitate informed decision-making for students.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a general schematic of a preferred embodiment of the system for educational investment analysis of the present application;

FIG. 2 is a flow diagram depicting the general methodology for educational investment analysis; and

FIG. 3 is a continuation of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional educational planning tools. Specifically, the system of the present invention integrates data analysis and scenario-based planning to provide a holistic and informed approach to educational investment decisions. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

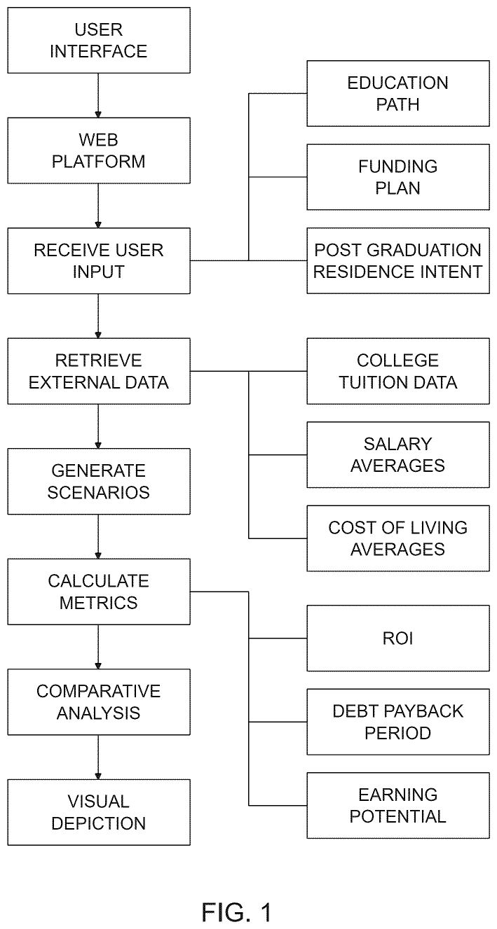

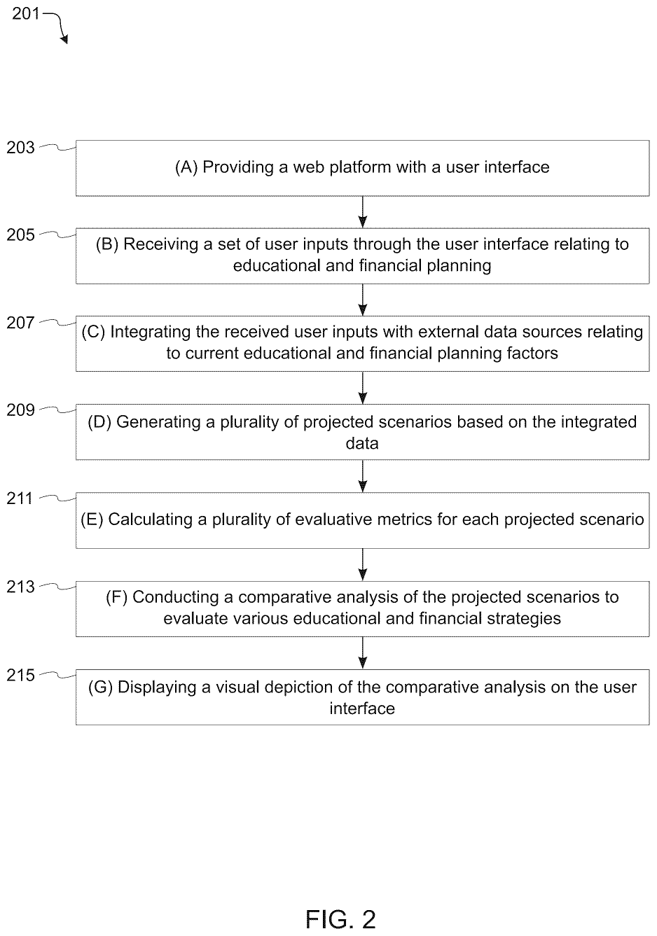

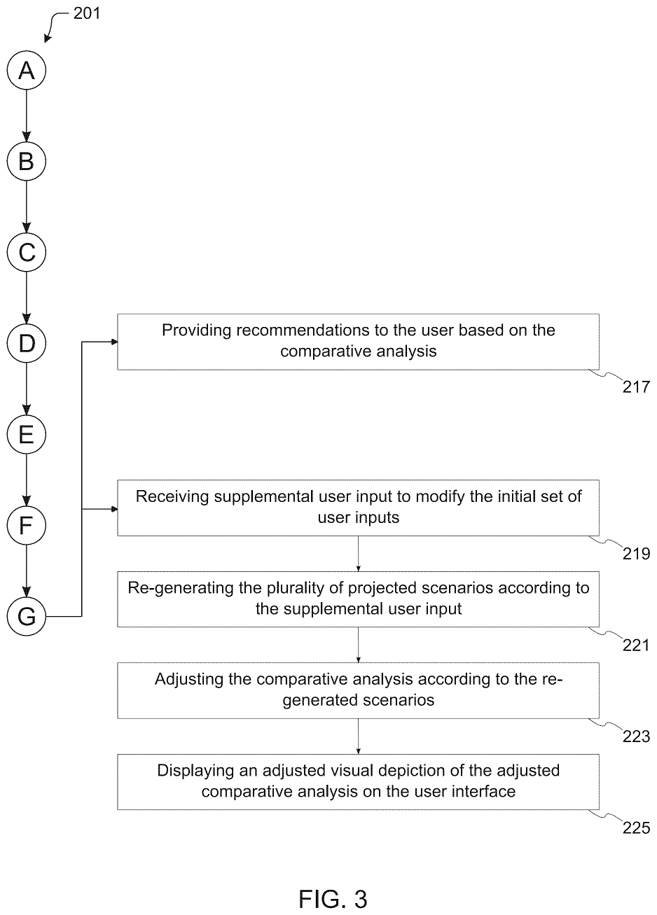

Referring now to the drawings wherein like reference characters identify corresponding or similar elements throughout the several views, FIGS. 1-3 depict a general system schematic and a method for educational investment analysis in accordance with a preferred embodiment of the present application. It will be appreciated that the system and method for educational investment analysis overcomes one or more of the above-listed problems commonly associated with conventional educational planning tools. In addition, it should be appreciated that more or fewer of such process steps and components may be included in different embodiments of the system and method.

In the contemplated embodiment, the method for educational investment 201 analysis initiates with the step 203 of providing a web platform equipped with a user interface. The web platform serves as the primary interaction point through which users engage with the system and proceed through the process of the present invention, while the user interface may be considered in the present disclosure to include any various means enabling said interaction, such as, but not limited to, a web browser or application through which the web platform is accessed, one or more specific pages on the web platform configured to receive or display inputs and/or outputs, form elements configured to receive specific inputs, regions or elements configured to display outputs, and the like.

Continuing in the method 201, a set of user inputs is received through the user interface relating to educational and financial planning 205. In the contemplated embodiment, said user inputs include information relating to the user's intended occupation, educational institutions being considered, funding plans, and intended region of residence after graduation. Additional input may include, but are not limited to, anticipated start year of study, living arrangements, and the like.

Subsequently, at step 207, data relating to current educational and financial planning factors is retrieved from external data sources and the received user inputs are integrated with the external data. The external data may include, but is not limited to, information on college tuition fees, average salaries by occupation, and the average cost of living in different regions.

The web platform then generates a plurality of projected scenarios at step 209, each projected scenario representing different prospective educational and financial outcomes based on different educational and financial choices. This generation of different scenarios is considered a core aspect of the present invention, allowing users to explore various possibilities based on potentially making different choices in their future educational and financial path.

For each projected scenario, a plurality of evaluative metrics is calculated 211. More particularly, in the contemplated embodiment, the evaluative metrics comprise a return on investment (ROI) and a debt repayment period. These evaluative metrics provide quantifiable insights into the potential outcomes of different educational and financial paths. Additionally, the evaluative metrics may further comprise a gross income earning potential, a net income earning potential, and various other metrics intended to provide predictive insights into quality of life after leaving college and entering the workforce.

Further, the method 201 includes conducting a comparative analysis of the projected scenarios to evaluate various educational and financial strategies 213. Moreover, a visual depiction of the comparative analysis is displayed on the user interface 215. The visual depiction is designed for clarity and ease of understanding and to this end may include graphical representations of the evaluative metrics. The visual depiction further enables side-by-side comparison of the projected scenarios. This facilitates a clear understanding of the implications of different potential educational and financial choices and aids the user in making well-informed decisions by providing a clear, concise representation of the comparative analysis and evaluative metrics. Further, in addition to providing the visual depiction and side-by-side comparison, the method 201 may further comprise the step 217 of providing recommendations to the user based on the comparative analysis, wherein the recommendations suggest optimal educational and financial strategies; for example, which educational institution to choose and what geographic region to seek employment in to maximize the user's ROI and minimize their debt repayment period.

It is also contemplated and will be appreciated that the method 201 can further incorporate features allowing users to modify their inputs to produce a correspondingly modified analysis. To this end, the method 201 further comprises the step 219 of receiving supplemental user input to modify the initial set of user inputs. Subsequently, at step 221, the plurality of projected scenarios is re-generated according to the supplemental user input, and the comparative analysis is adjusted accordingly 223. An adjusted visual depiction of the adjusted comparative analysis is then displayed on the user interface 225.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A computer-implemented method for educational investment analysis comprising the steps of:
providing a web platform with a user interface;
receiving a set of user inputs through the user interface relating to educational and financial planning;
integrating the received user inputs with external data sources relating to current educational and financial planning factors;
generating a plurality of projected scenarios based on the integrated data, wherein each projected scenario represents different prospective educational and financial outcomes based on different educational and financial choices;
calculating a plurality of evaluative metrics for each projected scenario;
conducting a comparative analysis of the projected scenarios to evaluate various educational and financial strategies; and
displaying a visual depiction of the comparative analysis on the user interface.

2. The method of claim 1, further comprising the step of providing recommendations to the user based on the comparative analysis, wherein the recommendations suggest optimal educational and financial strategies.

3. The method of claim 1, further comprising the steps of:
receiving supplemental user input to modify the initial set of user inputs;
re-generating the plurality of projected scenarios according to the supplemental user input;
adjusting the comparative analysis according to the re-generated scenarios; and
displaying an adjusted visual depiction of the adjusted comparative analysis on the user interface.

4. The method of claim 1, wherein the user inputs include information relating to the user's intended occupation, educational institutions, living arrangements, and funding plans.

5. The method of claim 1, wherein the external data sources include data related to college tuition, average salary by occupation, and average cost of living.

6. The method of claim 1, wherein the evaluative metrics comprises a return on investment (ROI).

7. The method of claim 1, wherein the evaluative metrics comprises a debt repayment period.

8. The method of claim 1, wherein the evaluative metrics comprises a gross income earning potential.

9. The method of claim 1, wherein the evaluative metrics comprises a net income earning potential.

10. The method of claim 1, wherein the visual depiction enables side-by-side comparison of the projected scenarios.

11. The method of claim 1, wherein the visual depiction of the comparative analysis includes graphical representations of the evaluative metrics for ease of comparison.
